(19) United States
(12) Patent Application Publication
(10) Pub. No.: US 2018/0304508 A1
(43) Pub. Date: Oct. 25, 2018

(54) INJECTION MOLDING APPARATUS

(71) Applicant: Mold-Masters (2007) Limited, Georgetown (CA)

(72) Inventors: Payman TABASSI, Rockwood (CA); Douglas URSU, Orangeville (CA)

(21) Appl. No.: 15/767,892

(22) PCT Filed: Oct. 7, 2016
(86) PCT No.: PCT/CA2016/051175

§ 371 Date: Apr. 12, 2018

Related U.S. Application Data
(60) Provisional application No. 62/240,045, filed on Oct. 12, 2015.
(60) Provisional application No. 62/240,050, filed on Oct. 12, 2015.

(51) Int. Cl. B29C 45/28

(52) U.S. Cl. CPC B29C 45/281; B29C 2045/2824

(57) ABSTRACT

A linear actuator for use in an injection molding apparatus is provided. The linear actuator comprises an electric motor including a drive shaft; an anti-rotation mechanism including a restrictor and a captive member, the captive member attached to the pin, the restrictor and the captive member arranged for translating a rotational motion of the drive shaft to a linear motion of the captive member, and by extension the pin, relative to the restrictor; and an adapter coupling the drive shaft with the captive member to enable the drive shaft to transmit the rotational motion of the drive shaft and to be readily decoupleable from the captive member without needing to separate the captive member from the pin.

### FIELD OF THE INVENTION

The invention relates generally to an injection molding apparatus and, in particular, to an injection molding apparatus using a linear actuator.

### BACKGROUND OF THE INVENTION

In injection molding, a melt delivery body such as a nozzle is used to dispense melt from a source into a cavity of the mold for creating an article therein. In a valve gated system, a pin, disposed and axially slideable in the melt channel of the nozzle, is used to control the flow of melt dispensed by the nozzle. Some valve gated system uses electric motors to drive the pin.

It is desirable to be able to separate the electric motor from the pin without having to separate the pin from the nozzle.

### BRIEF SUMMARY OF THE INVENTION

An aspect of the present application provides, in an injecting molding apparatus comprising a nozzle and a pin slideably disposed in the nozzle to control the flow of melt dispensed by the nozzle, a linear actuator comprising: an electric motor including a drive shaft; an anti-rotation mechanism including a restrictor and a captive member, the captive member attached to the pin, the restrictor and the captive member arranged for translating a rotational motion of the drive shaft to a linear motion of the captive member, and by extension the pin, relative to the restrictor; and an adapter coupling the drive shaft with the captive member to enable the drive shaft to transmit the rotational motion of the drive shaft and to be readily decoupleable from the captive member without needing to separate the captive member from the pin.

The drive shaft is readily decoupleable from the captive member without needing to separate the captive member from the pin by moving the drive shaft axially away from the captive member.

The adapter can include an externally threaded sleeve coupling the drive shaft with the captive member, the captive member can include an internally threaded channel corresponding to and engaging with the external thread of the externally threaded sleeve.

An external thread of the externally threaded sleeve can be ACME thread.

The drive shaft can have a non-circular cross-section and the externally threaded sleeve can include a non-circular channel for receiving and engaging the drive shaft therein.

The adapter can include a non-circular sleeve and the externally threaded sleeve can include a non-circular channel for receiving and engaging the non-circular sleeve therein, the non-circular sleeve attached to the drive shaft.

The cross-section of the non-circular sleeve can be “D” shaped.

The cross-section of the non-circular sleeve can be a polygon.

The cross-section of the non-circular sleeve can be hex shaped.

The non-circular sleeve can be attached to the drive shaft via a screw.

The non-circular sleeve can be attached to the drive shaft via an adhesive.

The linear actuator can further comprise a bearing wherein the externally threaded sleeve can include a flange at an end proximal to the electric motor and the bearing can be located between the flange of the externally threaded sleeve and a cover for absorbing the axial load acting on the threaded sleeve in a direction towards the motor.

The linear actuator can further comprise an o-ring situated between the flange of the externally threaded sleeve and an end of the captive member proximal to the electric motor.

The restrictor can define a spline channel and the captive member can include a spline shaft corresponding to and engaging the spline channel to enable the captive member to be axially but not rotationally movable relative to the restrictor.

The restrictor can define a non-circular channel and the captive member can include a non-circular shaft corresponding to and engaging with the non-circular channel of the restrictor to enable the captive member to be axially but not rotationally movable relative to the restrictor.

The adapter can include a ball screw having a threaded shaft and a ball assembly, the threaded shaft coupled to the drive shaft and the ball assembly attached to the captive member.

The drive shaft can have a non-circular cross-section and the threaded shaft of the ball screw can include a non-circular channel for receiving and engaging the drive shaft therein.

The adapter can include a non-circular sleeve and the threaded shaft of the ball screw can include a non-circular channel for receiving and engaging the non-circular sleeve therein, the non-circular sleeve attached to the drive shaft.

The linear actuator can further comprise a bearing wherein the threaded shaft of the ball screw can include a flange at an end proximal to the electric motor and the bearing can be located between the flange of the threaded shaft of the ball screw and a cover for absorbing the axial load acting on the threaded shaft of the ball screw in a direction towards the motor.

The linear actuator can further comprise an o-ring situated between the flange and the ball assembly.

### BRIEF DESCRIPTION OF THE DRAWINGS

The foregoing and other features and advantages of the invention will be apparent from the following description of embodiments thereof as illustrated in the accompanying drawings. The drawings are not to scale.

FIG. 1 is a side view of an injection molding apparatus in accordance with an embodiment of the present application;

FIG. 2 is a side partially cutaway view of a mold assembly of FIG. 1;

FIG. 3 is a side sectional view of an actuator plate, according to an embodiment of the present application;

FIG. 4 is a sectional view of a downstream end of a nozzle with a pin in the open position, according to an embodiment of the present application;

FIG. 5 is a sectional view of a downstream end of the nozzle of FIG. 4 with the pin in the closed position;

FIG. 6 is a side sectional view of a drive mechanism in the closed position, according to an embodiment of the present application;

FIG. 7 is an exploded view of a linear actuator, according to an embodiment of the present application;

FIG. 8 is an exploded view of a partial linear actuator, according to another embodiment of the present application;

FIG. 9 is an exploded view of a linear actuator, according to yet another embodiment of the present application;

FIG. 10 is a perspective view of the anti-rotation mechanism of FIG. 9;

FIG. 11 is an exploded view of the anti-rotation mechanism of FIG. 9;

FIG. 12 is an exploded view of a linear actuator, according to yet another embodiment of the present application;

FIG. 13 is a side sectional view of a drive mechanism of FIG. 12;

FIG. 14 is a perspective view of a ball screw of FIG. 12;

FIG. 15 is a side view of the disassembling of a linear actuator;

FIG. 16 is a sectional view of a captive member according to an embodiment of the present application;

FIG. 17 is a sectional view of the actuator plate with the captive member of FIG. 16; and

FIG. 18 is an exploded perspective view of an embodiment of the linear actuator of FIG. 12.

### DETAILED DESCRIPTION OF THE INVENTION

Specific embodiments of the present invention are now described with reference to the figures. The following detailed description is merely exemplary in nature and is not intended to limit the invention or the application and uses of the invention. Furthermore, there is no intention to be restricted by any expressed or implied theory in the present disclosure. In the description, “downstream” is used with reference to the direction of mold material flow from an injection unit of an injection molding apparatus to a mold cavity, and also with reference to the order of components, or features thereof, through which the mold material flows from the injection unit to the mold cavity, whereas “upstream” is used with reference to the opposite direction.

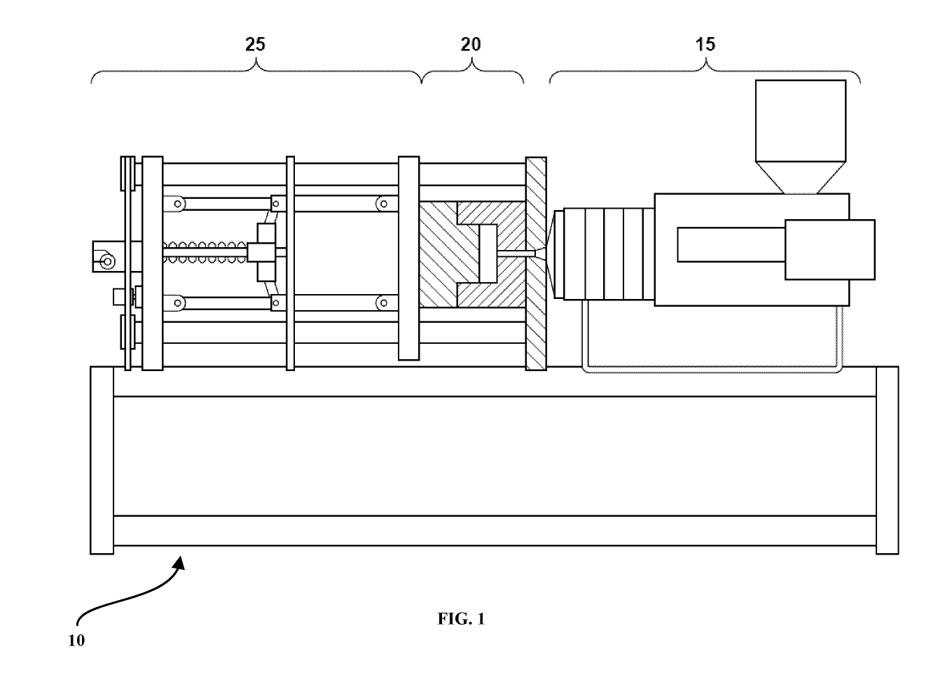

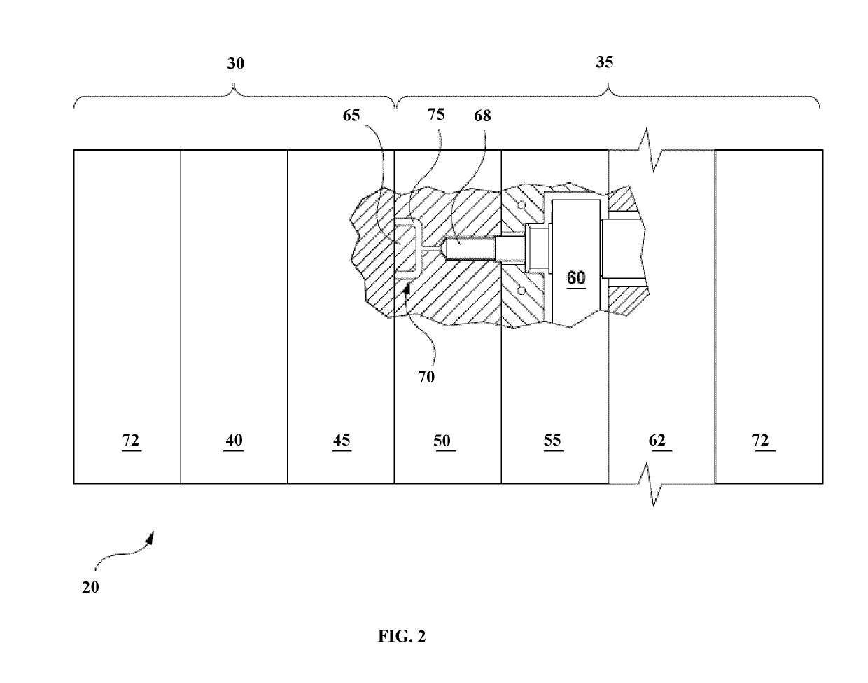

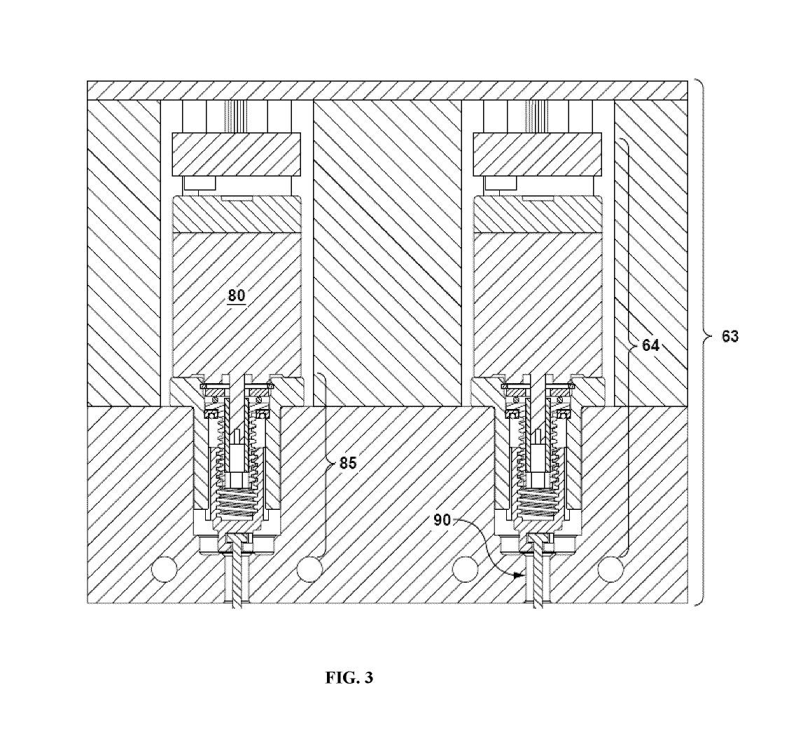

FIG. 1 is a side view of an injection molding apparatus 10 including an injection unit 15, a mold assembly 20, and a clamping unit 25. Referring to FIG. 2, mold assembly 20 includes a moving half 30 and a stationary half 35. Clamping unit 25 is configured to move moving half 30 towards stationary half 35 to close mold assembly 20 and away from stationary half 35 to open mold assembly 20. Moving half 30 includes a core plate 40 and a stripper plate 45. Stationary half 35 includes a cavity plate 50, a manifold plate 55 housing a manifold 60, and, depending on the application of injection molding apparatus 10, other plates 62 for housing other components of mold assembly 20. In the embodiments of the present application, other plates 62 include an actuator plate 63 for housing actuators 64 (see FIG. 3). (Persons of ordinary relevant skill in the art would appreciate that injection molding apparatus 10 can have one or more actuators 64.) According to the embodiments of the present application, actuators 64 are linear actuators (and will henceforth be referred to individually as linear actuator 64 and collectively as linear actuators 64). Mold assembly 20 is bounded by a clamp plate 72 on each end thereof (see FIG. 2).

Manifold 60 is a melt delivery body, which, depending on the application of injection molding apparatus 10, can include a network of melt channels (not shown) for distributing melt from injection unit 15 to nozzles 68 (and will henceforth be referred to individually as nozzle 68 and collectively as nozzles 68). Core plate 40 includes cores 65. Cavity plate 50 includes cavities 70 (and will henceforth be referred to individually as cavity 70 and collectively as cavities 70).

In operation, clamping unit 25 closes mold assembly 20 and clamps mold assembly 20 shut, in a closed position, to prevent mold assembly 20 from opening under the pressure of melt being injected, by injection unit 15, into cavities 70. With mold assembly 20 clamped in the closed position, melt is injected in to space 75, shaped and dimensioned to create an article (not shown), between core 65 and corresponding cavity 70. When the article is ready to depart mold assembly 20, the article clings to core 65. To remove the article from core 65, mold assembly 20 opens allowing stripper plate 45 to move upstream to eject the article from core 65.

FIG. 3 is a side sectional view of actuator plate 63, according to an embodiment of the present application. Linear actuator 64 includes an electric motor 80 for providing a rotational motion to drive linear actuator 64 and a drive mechanism 85 to convert the rotational motion of electric motor 80 to a linear motion of pin 90.

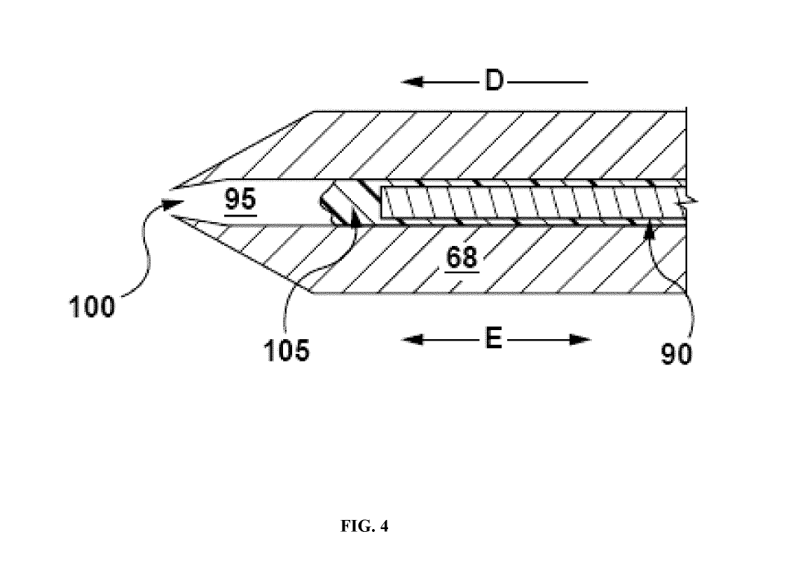

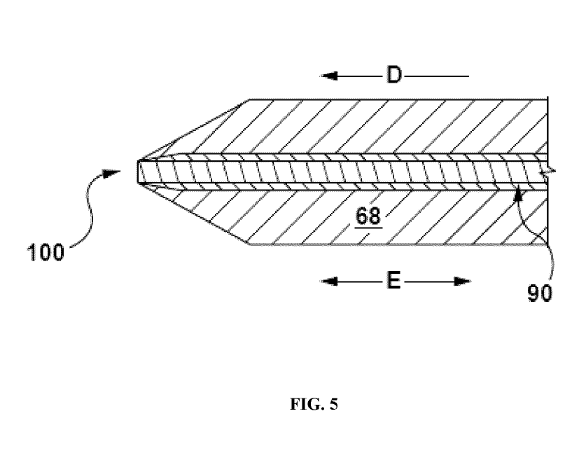

FIG. 4 is a sectional view of a downstream end of nozzle 68 with pin 90 in the open position, according to an embodiment of the present application. Nozzle 68 includes a melt channel 95 and an opening 100, through which melt 105 traveling in melt channel 95, in a direction D (i.e., downstream), exits nozzle 68 (i.e., dispensed from nozzle 68) into space 75 (see FIG. 2). Pin 90 can be used to control the flow rate of melt 105 through opening 100 by obstructing melt flow through opening 100. In the open position, pin 90 is retracted from opening 100 allowing melt 105 to flow substantially unobstructed through opening 100 (see FIG. 4). In the closed position, pin 90 is extended downstream to block opening 100 preventing melt 105 from flowing through opening 100 (see FIG. 5). The axial movement E of pin 90 is effected by linear actuator 64. (In some injection molding apparatuses, not shown, a pin regulates the amount of melt flowing into the cavity by blocking an opening at a gate insert located immediately upstream from the cavity. In injection molding apparatuses where the opening is part of the gate insert, the opening is commonly referred to as the gate.)

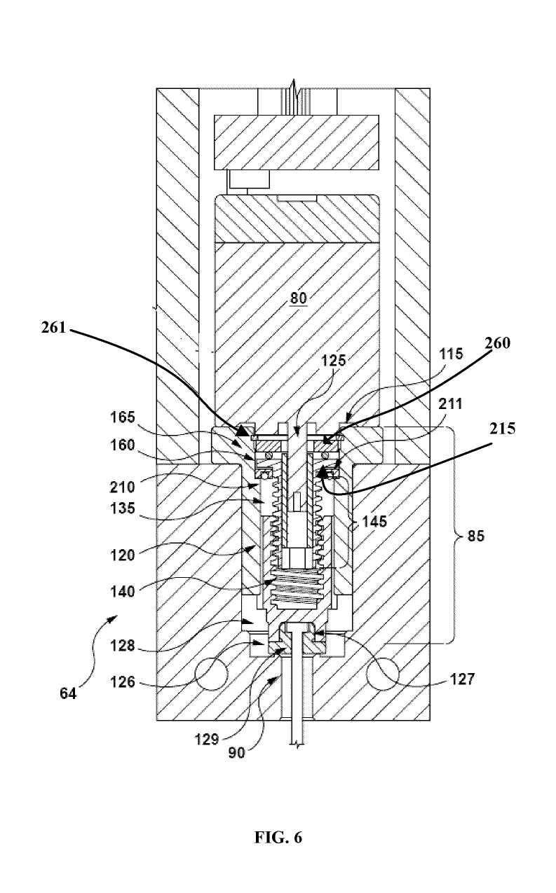

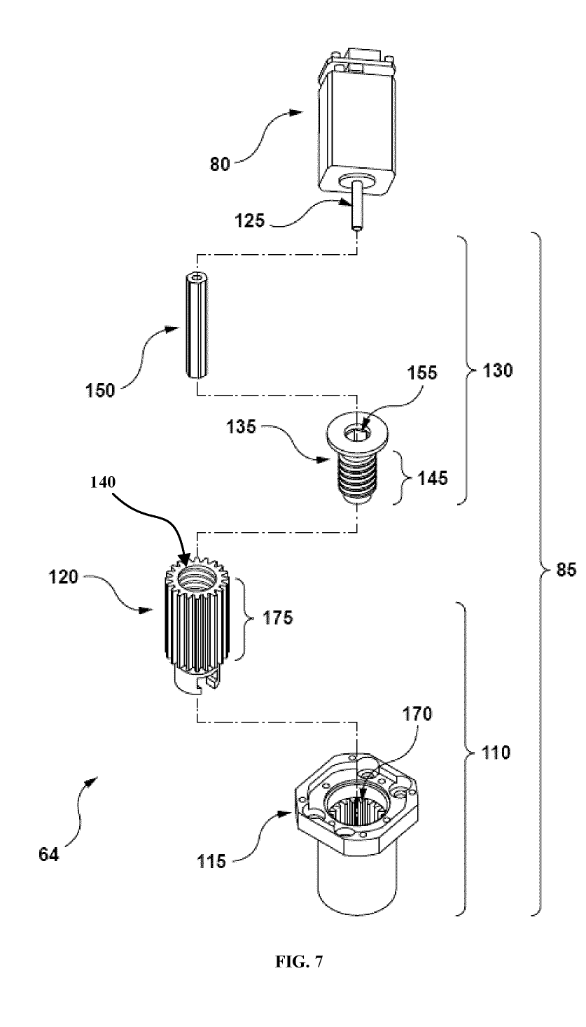

FIG. 6 is a side sectional view of drive mechanism 85, according to an embodiment of the present application. FIG. 7 is an exploded view of linear actuator 64. Referring to FIG. 6 and FIG. 7, drive mechanism 85 includes an anti-rotation mechanism 110 having a restrictor 115 and a captive member 120. Restrictor 115 and captive member 120 are arranged for translating a rotational motion of drive shaft 125 of electric motor 80 to a linear motion of captive member 120, and by extension pin 90, relative to restrictor 115. Referring to FIG. 6, captive member 120 can be attached to pin 90 via an externally threaded nut 126 threaded with a threaded channel 127 of captive member 120 at a downstream end 128 of captive member 120. Nut 126 includes a channel 129 to receive pin 90 therethrough.

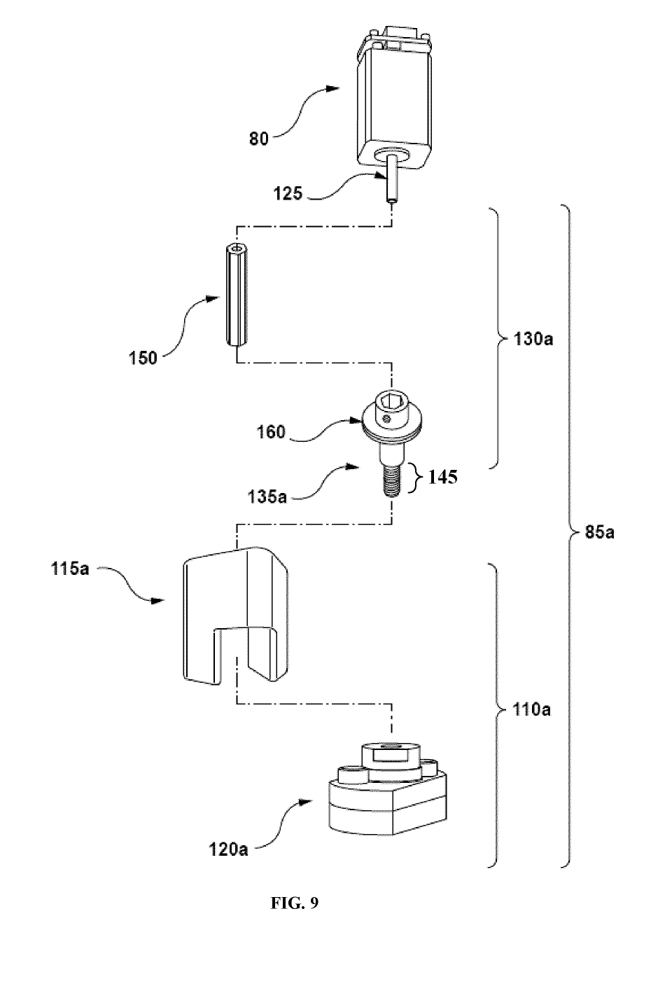

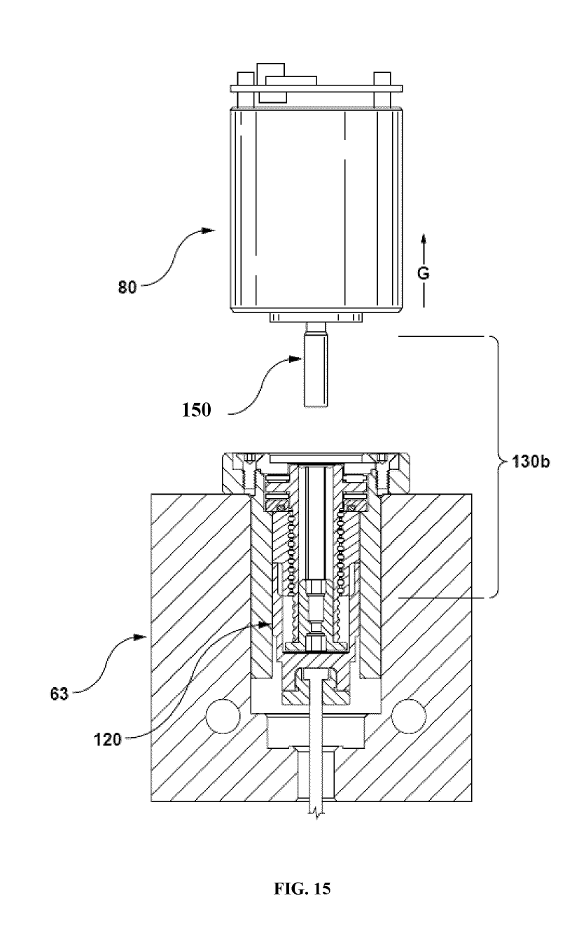

Linear actuator 64 also includes an adapter 130 coupling drive shaft 125 with captive member 120 to transmit the rotational motion of drive shaft 125 to captive member 120 and to enable drive shaft 125 to be readily decoupleable from captive member 120 without needing to separate captive member 120 from pin 90. In particular, drive shaft 125 is readily decoupleable from captive member 120 by moving drive shaft 125 axially away (e.g., in a direction G) from captive member 120 (see FIG. 15). In one embodiment, adapter 130 includes an externally threaded sleeve 135 having an external thread 145 for coupling drive shaft 125 with captive member 120 (see FIG. 7) by engaging an internally threaded channel 140 of captive member 120 (see FIG. 6). In some embodiments, external thread 145 of externally threaded sleeve 135 is an ACME thread. (Persons of ordinary relevant skill in the art would appreciate that external thread 145 can cover a partial portion or the entire length of externally threaded sleeve 135. See, for example, FIG. 7 and FIG. 9)

In the embodiment illustrated by FIG. 7, adapter 130 includes a non-circular sleeve 150 and externally threaded sleeve 135 includes a non-circular channel 155, matching the geometry of the cross-section of non-circular sleeve 150, for receiving and engaging non-circular sleeve 150 therein. When non-circular sleeve 150 is received in non-circular channel 155, non-circular channel 155 prevents non-circular sleeve 150 from rotating relative to externally threaded sleeve 135 but permits non-circular sleeve 150 to move axially, when an axial force is applied to non-circular sleeve 150, e.g., pulling non-circular sleeve 150 away from or pushing non-circular sleeve 150 towards externally thread sleeve 135. Non-circular sleeve 150 can be attached to drive shaft 125 by a screw, an adhesive, welding or other equivalent means. When assembled, with non-circular sleeve 150 attached to drive shaft 125, non-circular sleeve 150 fits snugly in, but can readily be separated from, non-circular channel 155, an arrangement that not only enables drive shaft 125 to rotate externally threaded sleeve 135, which in turn causes captive member 120 to move axially relative to restrictor 115 but allows drive shaft 125 to be readily decoupleable from captive member 120 by moving electric motor 80, and by extension drive shaft 125, in direction G (see FIG. 15). (That is, the friction between non-circular sleeve 150 and non-circular channel 155 couples non-circular sleeve 150 with non-circular channel 155. Separating non-circular sleeve 150 from non-circular channel 155 merely requires a substantially axial force to overcome the friction coupling non-circular sleeve 150 with non-circular channel 155.) Because pin 90 is attached to captive member 120, axial movement of captive member 120 results in axial movement of pin 90.

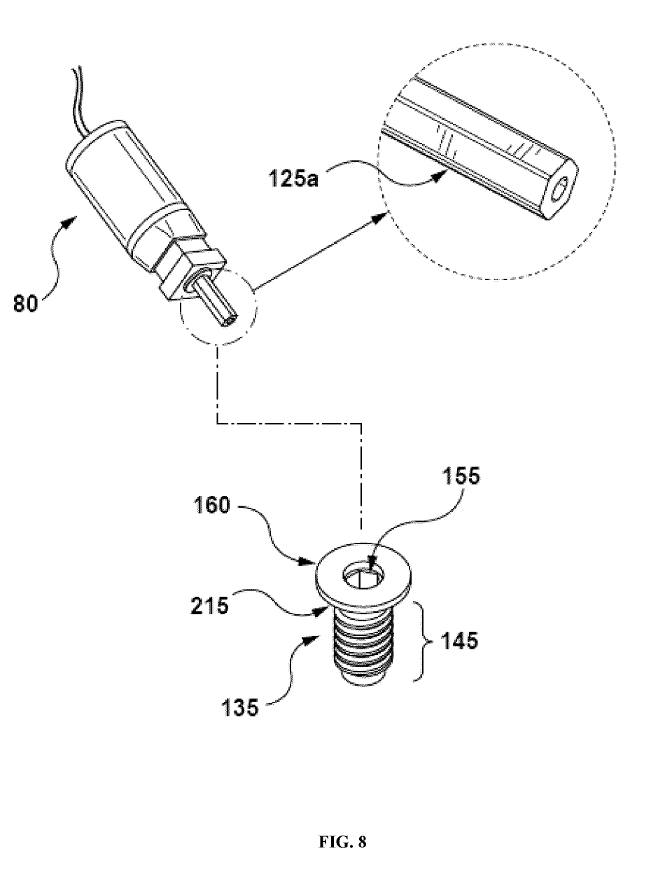

FIG. 8 is an exploded view of a partial linear actuator with a drive shaft 125a of electric motor 80 magnified, according to an embodiment of the present application. In the embodiment illustrated by FIG. 8, drive shaft 125a has a non-circular cross-section and externally threaded sleeve 135 includes non-circular channel 155, matching the geometry of the cross-section of drive shaft 125a, for receiving and engaging drive shaft 125a therein. (In the embodiment illustrated by FIG. 8, non-circular sleeve 150 is absent from adapter 130.) When drive shaft 125a is received in non-circular channel 155, non-circular channel 155 prevents drive shaft 125a from rotating but permits drive shaft 125a to move axially therein. When assembled, drive shaft 125a fits snugly in, but can readily be separated from, non-circular channel 155, an arrangement that not only enables drive shaft 125a to rotate externally threaded sleeve 135, which in turn causes captive member 120 to move axially relative to restrictor 115 but allows drive shaft 125a to be readily decoupleable from captive member 120 by moving electric motor 80, and by extension drive shaft 125a, in direction G (see FIG. 15). (That is, the friction between drive shaft 125a and non-circular channel 155 couples drive shaft 125a with non-circular channel 155. Separating drive shaft 125a from non-circular channel 155 merely requires a substantially axial force to overcome the friction coupling drive shaft 125a with non-circular channel 155.)

Depending on the application, non-circular cross-section of drive shaft 125a of FIG. 8, non-circular sleeve 150 of FIG. 7, and non-circular channel 155 of externally threaded sleeve 135 of FIG. 7 and FIG. 8 can be “D” shaped, a polygon, hex shaped or equivalents thereof.

Externally threaded sleeve 135 can include a flange 160 in the upstream portion thereof. Linear actuator 64 can include a bearing 165 located between flange 160 of externally threaded sleeve 135, a cover 260 upstream of flange 160, and a retainer ring 261 (partially retained in a groove inside restrictor 115) to divert the axial load acting on drive shaft 125 away from drive shaft 125 to retainer ring 261 (see FIG. 6). Cover 260 retains contents of restrictor 115 within restrictor 115.

In the embodiment of FIG. 7, restrictor 115 defines a spline channel 170 and captive member 120 includes a spline shaft 175 corresponding to and engaging spline channel 170 to enable captive member 120 to be axially but not rotationally movable relative to restrictor 115. Consequently, when externally threaded sleeve 135 rotates in internally threaded channel 140, external thread 145 engages the thread of internally threaded channel 140 of captive member 120 and because captive member 120 is restricted from rotating relative to restrictor 115, captive member 120 moves linearly relative to restrictor 115 in the form of movement E (see. FIG. 4 and FIG. 5).

Referring to FIG. 6, in some embodiments, linear actuator 64 can include an o-ring 210 situated between a downstream surface 215 of flange 160 and an upstream surface of its nearest downstream neighbour (e.g., captive member 120, 120a and ball nut 205) to reduce the risk of the adjacent opposing surfaces of the respective neighbouring components from jamming into each other when linear actuator 64 is in the open position. For example, in the embodiment illustrated by FIG. 6, o-ring 210 can be used to prevent captive member 120 from jamming with downstream surface 215 of flange 160. O-ring 210 can be housed in a washer 211. O-ring 210 can be made of rubber, silicone, or equivalents thereof.

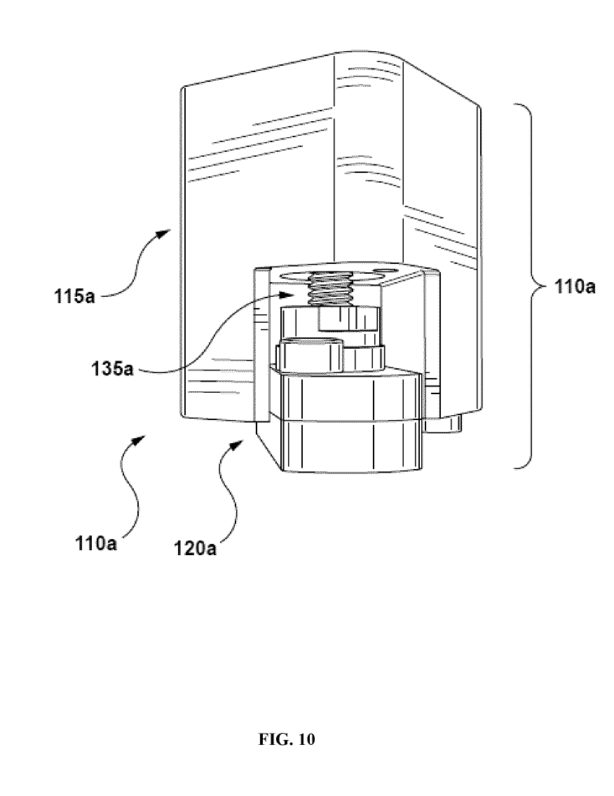

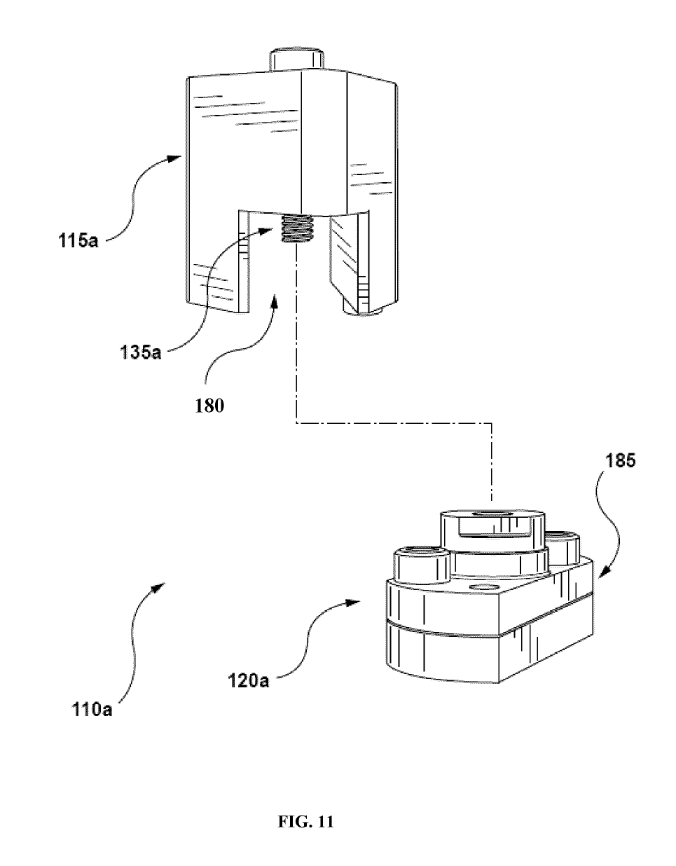

FIG. 9, FIG. 10, and FIG. 11 illustrate another embodiment of drive mechanism 85 of FIG. 7, referenced as drive mechanism 85a. The reference numbers used in FIG. 7 are used to identify like components in FIG. 9, FIG. 10, and FIG. 11. Components of drive mechanism 85a that are alternatives to their respective counterpart components of drive mechanism 85 bear the same reference number as their counterpart components except suffixed by the letter “a”. Drive mechanism 85a differs from drive mechanism 85 in that anti-rotation mechanism 110a includes restrictor 115a and captive member 120a in place of restrictor 115 and captive member 120, respectively. Restrictor 115a defines a non-circular channel 180 and captive member 120a includes a non-circular shaft 185 corresponding to and engaging with non-circular channel 180 of restrictor 115a to enable captive member 120a to be axially but not rotationally movable relative to restrictor 115a (see FIG. 11).

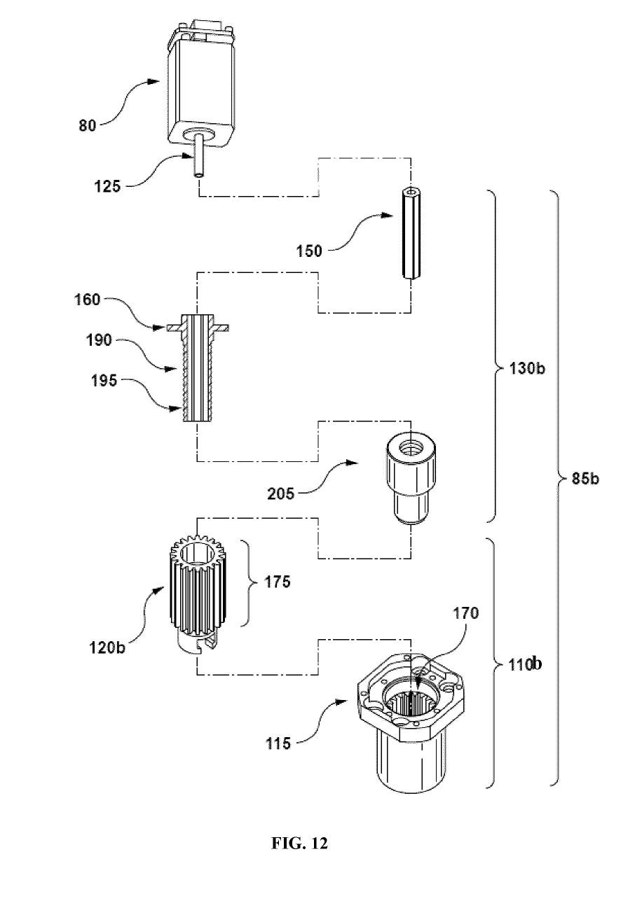

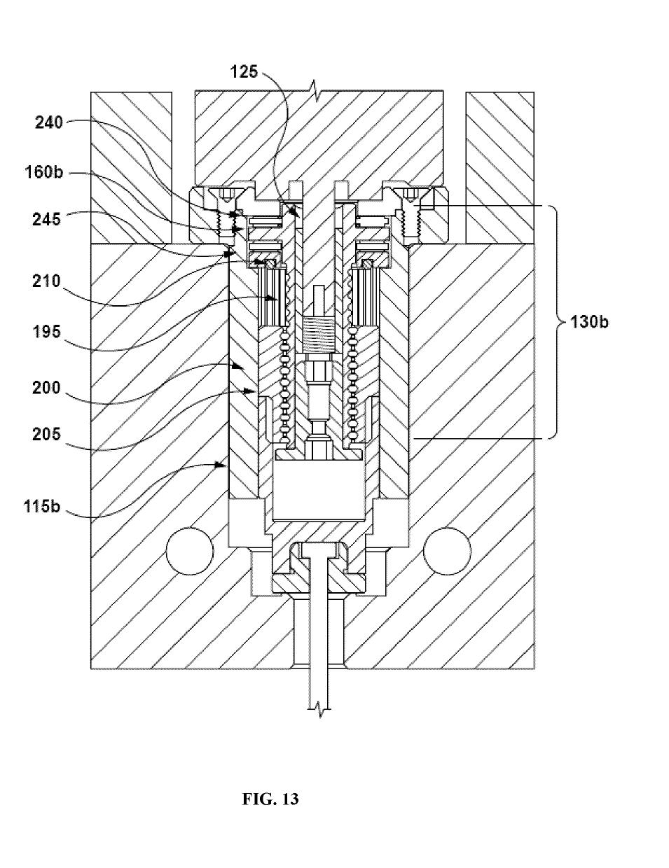

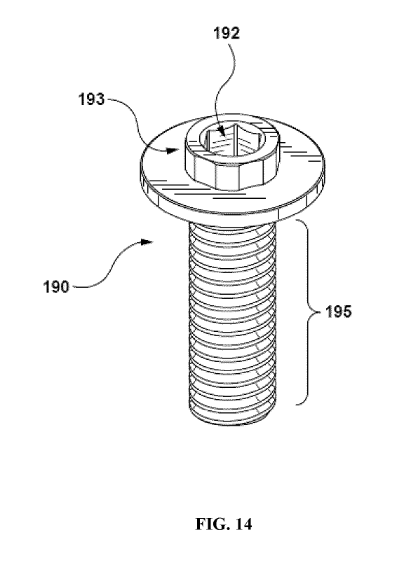

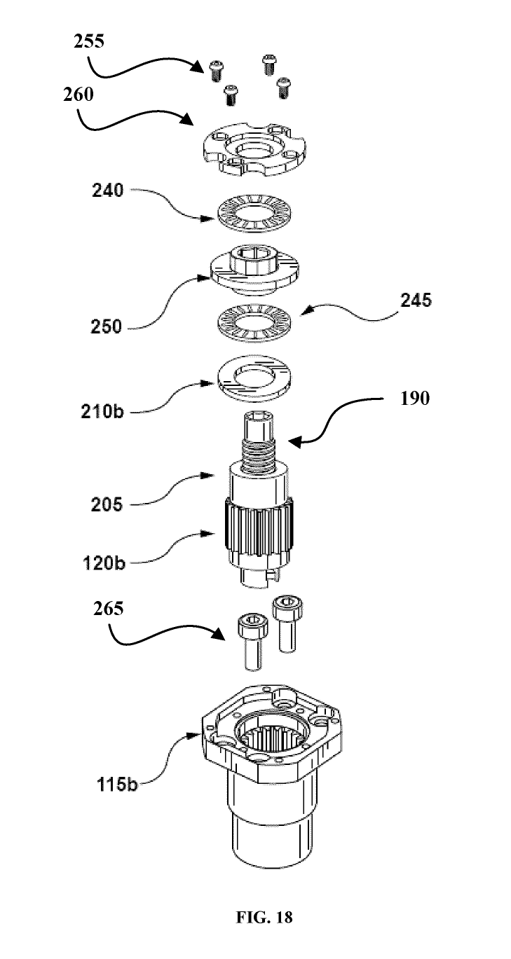

FIG. 12, FIG. 13, and FIG. 14 illustrate yet another embodiment of drive mechanism 85 of FIG. 7, referenced as drive mechanism 85b. The reference numbers used in FIG. 7 are used to identify like components in FIG. 12, FIG. 13, and FIG. 14. Components of drive mechanism 85b that are alternatives to their respective counterpart components bear the same reference number as their counterpart components except suffixed by the letter “b”. In the embodiment illustrated by FIG. 12, FIG. 13, and FIG. 14, adapter 130b is an alternative to adapter 130 of FIG. 7. Adapter 130b includes a ball screw 190 having a threaded shaft 195 and a ball assembly 200 having a ball nut 205. Ball screw 190 defines a non-circular channel 192 (see FIG. 14) at an end 193 proximal to electric motor 80 to couple ball screw 190 to drive shaft 125. Ball screw 190 can be coupled to drive shaft 125 via non-circular sleeve 150. In embodiments with drive shaft 125a (see FIG. 8) having a non-circular cross-section corresponding to non-circular channel 192 of ball screw 190, non-circular sleeve 150 is omitted and ball screw 190 can be coupled directly with drive shaft 125a via the insertion of drive shaft 125a directly into non-circular channel 192 of ball screw 190. Ball assembly 200 can be attached to captive member 120b by threading ball assembly 200 to captive member 120b or equivalents thereof. Bearings 240, 245 facilitate rotation of ball screw 190 during the closing and opening of pin 90, respectively. Flange 160b can be integral with ball screw 190 (see FIG. 12 and FIG. 13) or a separate piece (referenced as 250 in FIG. 18) coupled to ball screw 190. Screws 255 can be used to secure cover 260 to restrictor 115b (see FIG. 18). Screws 265 can be used to secure restrictor 115b to actuator plate 63 (see FIG. 18).

In operation, electric motor 80, via drive shaft 125, rotates externally threaded sleeve 135 to impart axial movement E on pin 90 (see FIG. 4) to effect closing (see FIG. 5) or opening of opening 100 (see FIG. 4). The direction of movement E of pin 90 depends on the angular direction of rotation of drive shaft 125. Similarly, for the embodiment illustrated by FIG. 12, electric motor 80, via drive shaft 125, rotates ball screw 190 to impart axial movement E on pin 90 to effect closing (see FIG. 5) or opening (see FIG. 4) of opening 100.

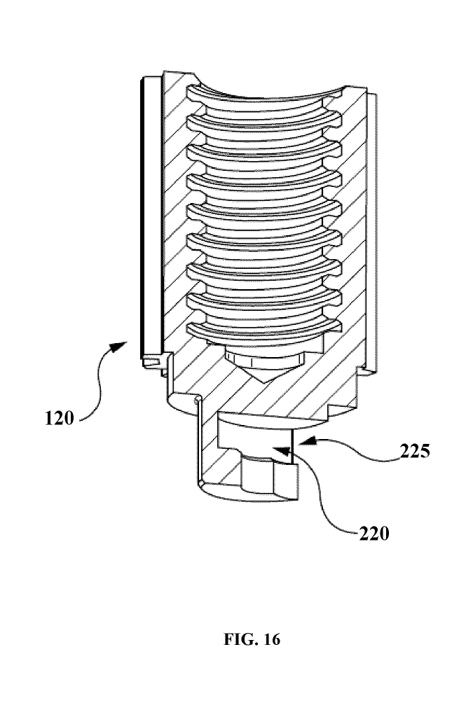

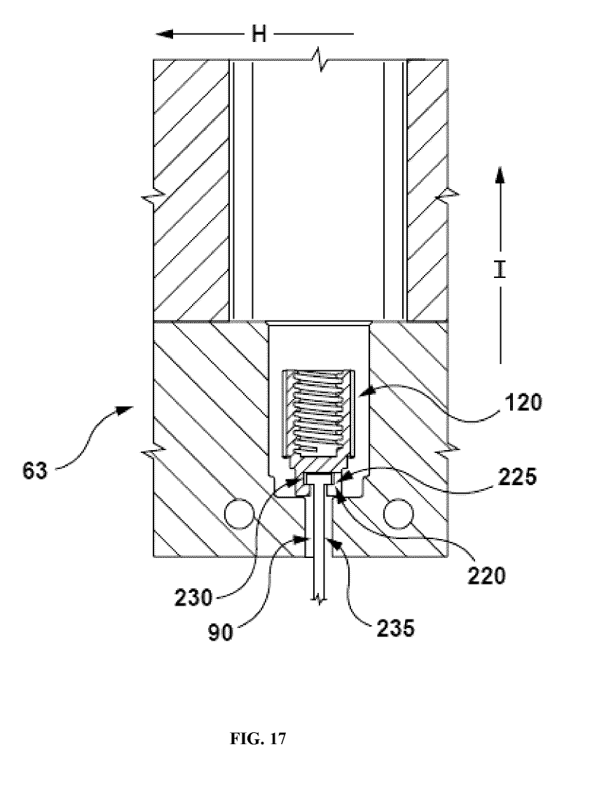

Referring to FIG. 16 and FIG. 17, in some embodiments, captive member 120 can include a pin head slot 220 with an opening 225 for receiving a pin head 230 of pin 90 into pin head slot 220. Pin head slot 220 has a generally T-shaped cross-section to capture pin head 230 therein. With pin head 230 captured in pin slot 220, axial movement of captive member 120 is translated into axial movement of pin 90. Pin head slot 220 can facilitate the removal of actuator plate 63 from the injection molding apparatus 10 without needing to also remove pins 90 therefrom. With other components separated from captive member 120 and removed from actuator plate 63, captive member 120 can be moved radially in a direction H (i.e., away from opening 225) to clear pin head 230 from pin head slot 220 so that captive member 120 can be separated from actuator plate 63 by moving captive member 120 in the upstream direction (i.e., in a direction I). With captive member 120 removed from actuator plate 63 and bore 235 sized large enough to allow pin head 230 to pass therethrough, actuator plate 63 can be separated from the remainder of stationary half 35 without needing to remove pins 90 therefrom. (A person of ordinary skill in the art would appreciate that captive members 120a and 120b can also be facilitated with pin head slot 220.)

By coupling electric motor 80 with captive member 120, via adapter 130, 130b, electric motor 80 can be decoupled from captive member 120 by moving electric motor 80 (and by extension, drive shaft 125) axially away from captive member 120 (i.e., in direction G) (see FIG. 15) without needing to separate captive member 120 from pin 90. In injection molding that uses a hot runner, when an electric motor driving an actuator fails, it may be necessary to cool the melt delivery bodies such as the manifold and the nozzles down, to service the malfunctioned electric motor. However, when plastic, in melt delivery bodies, cools, the plastic hardens and can seize the pins, a condition that may require excessive force to remove the pins from the melt delivery bodies. The present application allows pin 90 to remain in the melt delivery bodies while electric motor 80 is separated from injection molding apparatus 10 by axially moving electric motor 80 away from captive member 120 (see FIG. 15).

While various embodiments according to the present invention have been described above, it should be understood that they have been presented by way of illustration and example only, and not limitation. It will be apparent to persons of ordinary relevant skill in the relevant art that various changes in form and detail can be made therein without departing from the scope of the invention. It will also be understood that each feature of each embodiment discussed herein, may be used in combination with the features of any other embodiment. For example, adapters 130, 130a, 130b can interchangeably be paired with anti-rotation mechanisms 110, 110a, the pairing illustrated by the figures are for providing example pairings, persons of ordinary relevant skill in the art would appreciate that other pairings are possible. For another example, adapter 130b can be paired with anti-rotation 110a. Thus, the breadth and scope of the present invention should not be limited by the above-described exemplary embodiments, but should be defined only in accordance with the appended claims and their equivalents.

1. A linear actuator for use in an injection molding apparatus having a nozzle and a pin slideably disposed in the nozzle to control the flow of melt dispensed by the nozzle, the linear actuator comprising:
an electric motor including a drive shaft;
an anti-rotation mechanism including a restrictor and a captive member, the drive shaft axially aligned with the anti-rotation mechanism, the captive member being configured to be coupled to the pin via radial movement of the captive member towards the pin and decoupled from the pin via radial movement of the captive member away from the pin, the restrictor and the captive member arranged for translating a rotational motion of the drive shaft to a linear motion of the captive member, and by extension the pin, relative to the restrictor; and
an adapter coupling the drive shaft with the captive member to enable the drive shaft to transmit the rotational motion of the drive shaft and to be readily decoupleable from the captive member without needing to separate the captive member from the pin.

2. The linear actuator of claim 1, wherein the drive shaft is readily decoupleable from the captive member without needing to separate the captive member from the pin by moving the drive shaft axially away from the captive member.

3. The linear actuator of claim 1, wherein the captive member includes a slot having a radial opening for radial movement of a pin head of the pin into and out of the slot.

4. The linear actuator of claim 2, wherein the adapter includes an externally threaded sleeve coupling the drive shaft with the captive member, and the captive member includes an internally threaded channel corresponding to and engaging with the external thread of the externally threaded sleeve.

5. The linear actuator of claim 4, wherein the drive shaft has a non-circular cross-section and the externally threaded sleeve includes a non-circular channel for receiving and engaging the drive shaft therein.

6. The linear actuator of claim 4, wherein the adapter includes a non-circular sleeve and the externally threaded sleeve includes a non-circular channel for receiving and engaging the non-circular sleeve therein, the non-circular sleeve attached to the drive shaft.

7. The linear actuator of claim 6, wherein the cross-section of the non-circular sleeve is “D” shaped.

8. The linear actuator of claim 6, wherein the cross-section of the non-circular sleeve is a polygon.

9. The linear actuator of claim 8, wherein the cross-section of the non-circular sleeve is hex shaped.

10. The linear actuator of claim 6, wherein the non-circular sleeve is attached to the drive shaft via a screw.

11. The linear actuator of claim 6, wherein the non-circular sleeve is attached to the drive shaft via an adhesive.

12. The linear actuator of claim 4 further comprising a bearing wherein the externally threaded sleeve includes a flange at an end proximal to the electric motor and the bearing is located between the flange of the externally threaded sleeve and a cover for absorbing the axial load acting on the threaded sleeve in a direction towards the motor.

13. The linear actuator of claim 12 further comprising an o-ring situated between the flange of the externally threaded sleeve and an end of the captive member proximal to the electric motor.

14. The linear actuator of claim 4, wherein the restrictor defines a spline channel and the captive member includes a spline shaft corresponding to and engaging the spline channel to enable the captive member to be axially but not rotationally movable relative to the restrictor.

15. The linear actuator of claim 4, wherein the restrictor defines a non-circular channel and the captive member includes a non-circular shaft corresponding to and engaging with the non-circular channel of the restrictor to enable the captive member to be axially but not rotationally movable relative to the restrictor.

16. The linear actuator of claim 3, wherein the adapter includes a ball screw having a threaded shaft and a ball assembly, the threaded shaft coupled to the drive shaft and the ball assembly attached to the captive member.

17. The linear actuator of claim 16, wherein the drive shaft has a non-circular cross-section and the threaded shaft of the ball screw includes a non-circular channel for receiving and engaging the drive shaft therein.

18. The linear actuator of claim 16, wherein the adapter includes a non-circular sleeve and the threaded shaft of the ball screw includes a non-circular channel for receiving and engaging the non-circular sleeve therein, the non-circular sleeve attached to the drive shaft.

19. The linear actuator of claim 16 further comprising a bearing wherein the threaded shaft of the ball screw includes a flange at an end proximal to the electric motor and the bearing is located between the flange of the threaded shaft of the ball screw and a cover for absorbing the axial load acting on the threaded shaft of the ball screw in a direction towards the motor.

20. The linear actuator of claim 19 further comprising an o-ring situated between the flange and the ball assembly.
